(19) United States
(12) Patent Application Publication
(10) Pub. No.: US 2005/0164698 A1
(43) Pub. Date: Jul. 28, 2005

(54) Method of fallback from a multimedia connection set-up request to an audio connection set-up request by determining the capacity of the connection at the called end

(75) Inventors: Gilles Francois, Antony (FR); Serge Lahore-Lahitte, Beynes (FR); Jean Rzeznik, Bagneux (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/033,701

(22) Filed: Jan. 13, 2005

(30) Foreign Application Priority Data
Jan. 14, 2004 (FR) 04 00 325

(51) Int. Cl. H04M 11/00

(52) U.S. Cl. 455/422.1

(57) ABSTRACT

A communications installation includes at least one cellular communications network that does not have an NGN architecture and to which communications terminals are connected. When the installation receives (F1), from a calling mobile terminal (T1), a request to set up a multimedia connection with a called terminal (T2), it attempts to set up that multimedia connection (F3-F4) and, if it fails to do so, it attempts to set up an audio connection between the calling and called terminals (F5-F9).

The field of the invention is that of communications networks, to be more precise that of setting up connections within communications networks.

Some communications terminals are adapted to exchange multimedia data as well as audio data. In the present context, the expression “communications terminal” means any fixed, mobile, or itinerant network equipment capable of exchanging data with a communications network, which may optionally be a mobile communications network.

As the person skilled in the art is aware, when a calling terminal of the above kind wishes to exchange multimedia data with a called remote terminal, it must first of all send a multimedia connection set-up request designating the called terminal to the network to which it is itself connected, in order for the network to attempt to set up the requested connection.

However, the requested connection cannot be set up if the network to which the called terminal is directly or indirectly connected does not support multimedia connections (or services) or if the called terminal does not support multimedia connections.

To enable a connection to be set up despite this, a procedure has been proposed for fallback to a request to set up an audio connection. This fallback procedure, which is defined by the 3GPP Technical Specification TS 23.172, is based on the calling and called terminals exchanging the types of transcoding (or codecs) they support, where multimedia and audio are each considered as respective codecs.

The drawback of that fallback procedure is that the supported codecs can be exchanged only within mobile networks with the New Generation Network (NGN) architecture. In other words, the fallback procedure can be used only in situations in which the networks to which the calling and called parties are connected, and any intermediate transit network(s), all have an NGN architecture.

Thus an object of the invention is to improve on the above situation, in particular in the case of communications installations constituted by, or at least including, at least one communications network that does not support multimedia connections.

To this end the invention proposes a method of fallback from a multimedia connection set-up request to an audio connection set-up request in a communications installation including at least one cellular communications network that does not have an NGN architecture, which method, on receipt of a request to set up a multimedia connection between a calling mobile terminal and a called terminal, attempts to set up said multimedia connection with said called terminal and then, if it is impossible to set up said multimedia connection, attempts to set up an audio connection between said calling terminal and said called terminal.

It may be impossible to set up a multimedia connection because the network to which the called terminal is directly or indirectly connected does not support this type of connection (or service) or because the called terminal does not support this type of connection.

On receipt of said multimedia connection set-up request, said calling terminal is preferably sent an acknowledgement indicating that its request will be processed.

Set-up is preferably attempted by sending a multimedia connection set-up request to a called switching centre that manages the connections of the called terminal.

When the called switching centre receives the request and finds that it is impossible to set up the requested connection, a response message is generated that preferably contains data indicating why this is impossible (for example because no multimedia connection is implemented).

When it receives from the called switching centre the indication that it is impossible to set up the multimedia connection, the calling switching centre may initiate fallback by sending the called switching centre a request to set up a fallback audio connection between the calling and called terminals, where applicable as a function of the cause received. When the called switching centre receives the request to set up a fallback audio connection, a response message may then be generated containing data indicating whether it is possible or impossible to set up an audio connection with the called terminal.

If fallback is initiated, the calling terminal is preferably sent a message indicating fallback and requiring it to send a message accepting (or refusing) fallback. The audio connection between the calling and called terminals is set up if the calling terminal accepts fallback.

Multimedia connection set-up and audio connection set-up are preferably attempted by the mobile switching centre to which the calling terminal is connected.

The invention also proposes a mobile switching centre for a communications installation that includes at least one cellular communications network that does not have an NGN architecture, which mobile switching centre comprises processing means adapted to implement a fallback method of the kind described hereinabove.

The invention is particularly well suited, although not exclusively so, to communications installations including at least one GSM, GSM/GPRS, or UMTS cellular communications network.

Other features and advantages of the invention will become apparent on reading the following detailed description and on examining the appended drawings, in which:

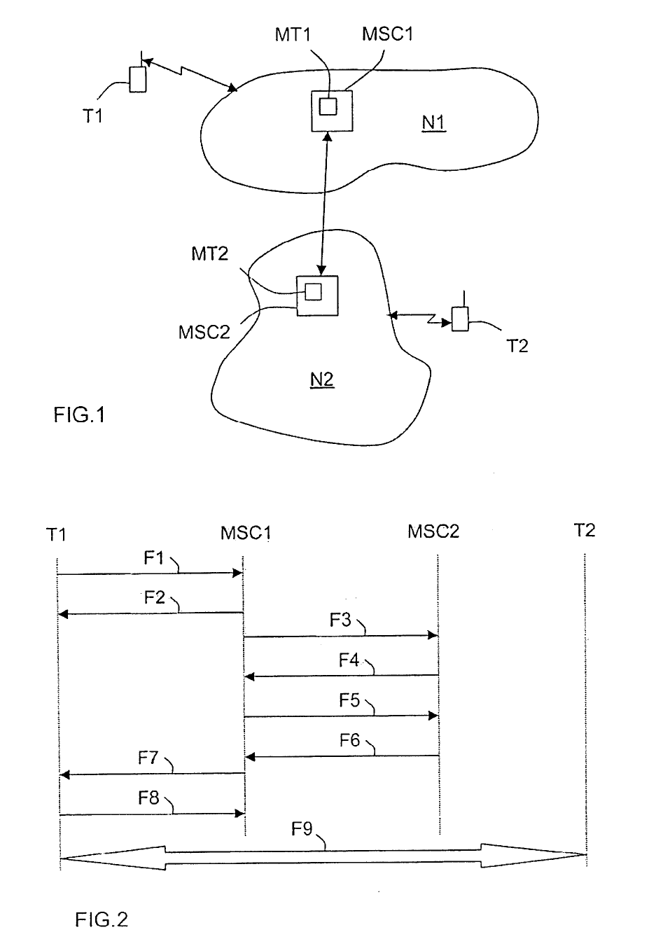

FIG. 1 is a diagram that shows a portion of a communications installation suitable for implementing a fallback method of the invention, and

FIG. 2 is a diagram that shows the main and complementary steps of the fallback method of the invention.

The appended drawings constitute part of the description of the invention as well as contributing to the definition of the invention, if necessary.

The invention relates to a fallback method for use in a communications installation comprising a public land mobile network (PLMN) cellular communications network that does not have a NGN architecture, for example a 2G network such as a GSM network, a 2.5G network such as a GSM/GPRS network, or a 3G network such as a UMTS network. The invention also relates to a mobile switching centre adapted to implement the fallback method.

In the non-limiting example shown in FIG. 1, the communications installation comprises two cellular networks N1 and N2. For example, the network N1 is a New Generation Network (NGN) and supports multimedia services and the network N2 is a GSM network and supports audio services but not multimedia services. Of course, many other installations could be envisaged, in particular an installation comprising communications networks supporting multimedia services (at least one of which networks is a cellular network) but which are interconnected by one or more networks that do not support multimedia services, or an installation comprising a single cellular communications network supporting multimedia services but not having a NGN architecture, and having communications terminals connected thereto, some of which support multimedia connections while others of which support only audio connections.

In the present context, the expression “communications terminal” means any fixed, mobile, or itinerant network equipment capable of exchanging data with a communications network, optionally a mobile (or similar) communications network. The communications terminals considered below by way of illustrative example are mobile telephones, but they could be fixed telephones, personal digital assistants (PDA), or fixed or portable computers equipped with a radio communications interface.

Generally speaking, the invention relates to all situations in which a mobile first communications terminal wishes to exchange multimedia data with a second communications terminal, but in which this is impossible either because the network to which the second terminal is directly or indirectly connected does not support multimedia connections (or services) or because the called second terminal does not support multimedia connections. Consequently, the invention relates to calls between mobile terminals of different types connected to the same PLMN (and not NGN) cellular network, or to calls between mobile terminals, where applicable of different types, connected to different PLMN cellular networks (at least one of which is not an NGN), or to calls between mobile and fixed terminals connected to a public switched telephone network (PSTN), provided that the networks concerned support signaling that allows the setting up of multimedia and audio connections, for example ITU ISUP signaling as described below.

Because the architecture of the communications networks is not relevant to the invention, it is not described in detail herein. Suffice it to say, that a cellular network comprises a radio access network RAN connected via an interface to a core network CN that may itself be connected to one or more other public and/or private networks. The core network CN comprises a mobile switching centre MSC connected to said interface and to at least one other network, such as a PLMN. The mobile switching centre MSC executes the operations necessary for managing circuit-mode communication with mobile terminals T.

The radio access network generally comprises, firstly, a plurality of nodes that are called radio network controllers (RNC) in a UMTS network and base station controllers (BSC) in a GSM network, connected to the core network CN via the aforementioned interface and, secondly, a plurality of base transceiver stations BTS in the case of a GSM network or a plurality of Nodes B in an the case of a UMTS network, each associated with one or more cells (radio coverage areas) and connected to one of the radio network controllers via a logical interface and individually or in groups of two or more.

The method of the invention of fallback from a multimedia connection set-up request to an audio connection set-up request is described below with reference to FIG. 2.

When a calling mobile terminal T1 that is connected to the first network N1, and in particular to its mobile switching centre MSC1, is required by its user to exchange multimedia data with a called remote terminal T2 that is connected to the second network N2, and in particular to its mobile switching centre MSC2, it first sends the network N1 a multimedia connection set-up request designating the called terminal T2.

That request is sent via the radio access network to the core network of the network N1, which forwards it to its mobile switching centre MSC1, as shown by the arrow F1.

This request, generally referred to as a “SETUP message”, comprises, in addition to the identifier of the called terminal T2, data indicating that the calling terminal T1 supports multimedia and audio connections. This data preferably consists of bearer capability identifiers BC1 and BC2.

The mobile switching centre MSC1 comprises a processing module MT1 for managing the fallback procedure for terminals that are connected to it.

As shown by the arrow F2, on receiving the request (SETUP message), the processing module MT1 of the mobile switching centre MSC1 sends the calling terminal T1 an acknowledgement message (“CALL PROCEEDING”) to tell it that its request has been received and will be processed.

At substantially the same time as this acknowledgement is sent, or just afterwards, the processing module MT1 attempts to set up the multimedia connection to the terminal T2, as shown by the arrow F3. To this end, it generates a multimedia connection set-up request designating the called terminal T2 and sends the request to the mobile switching centre MSC2 which manages the connections of the called terminal T2 designated in the received request, and in the case of ITU ISUP signaling the request takes the form of an “ISUP Initial Address Message”.

This ISUP IAM message asks the mobile switching centre MSC2 if it is possible to set up a multimedia connection with the called terminal T2. To this end, it contains data representative of the type of multimedia connection required, for example a Transmission Medium Requirement (TMR) field whose value is UDI 64 kbit/s. As mentioned above, for it to be possible to set up the connection, the called terminal T2 must support multimedia connections and the network N2 must support a multimedia service.

If the multimedia connection can be set up, the set-up procedure is executed conventionally, which amounts to proceeding directly to the bidirectional arrow F9.

If the multimedia connection cannot be set up, for example because the network N2 does not support a multimedia service, the processing module MT2 of the mobile switching centre MSC2 generates a response message containing data representative of why it is impossible, for example a Cause field whose value might be “BearerCapabilityNotimplemented”, for example. This response message is the “ISUP RELEASE message” in the case of ITU ISUP signaling. As shown by the arrow F4, this message is sent to the mobile switching centre MSC1 that previously sent the multimedia connection set-up request.

When the mobile switching centre MSC1 receives the response message, it forwards it to its processing module MT1 for the latter to analyze its content, and in particular the content of the Cause field. In this example, the processing module MT1 deduces from the value of the Cause field that the multimedia connection cannot be set up. To do this, the processing module MT1 preferably compares the value of the Cause field to at least one selected cause, for example the BearerCapabilityNotimplemented cause previously referred to, and proceeds with fallback only if the cause is identical to the selected cause.

If this is the case, the processing module MT1 attempts to set up an audio fallback connection, as shown by the arrow F5. To this end, it generates and sends to the mobile switching centre MSC2 a audio fallback connection set-up request, which takes the form of an ISUP IAM message in the case of ITU ISUP signaling. This ISUP IAM fallback message asks the mobile switching centre MSC2 if it is possible to set up an audio connection with the called terminal T2. To this end it contains data representative of the type of audio connection required, for example a TMR field whose value is “3.1 kHz audio” or “speech”.

On receiving the fallback message, the processing module MT2 of the mobile switching centre MSC2 generates a response message comprising data representative of the response. In the case of ITU ISUP signaling, this message is the “ISUP Address Complete Message” (ISUP ACM) or the “ISUP CONNECT message”. As shown by the arrow F6, this fallback response message is sent to the mobile switching centre MSC1 that previously sent the fallback message.

When the mobile switching centre MSC1 receives the response message, it forwards it to its processing module MT1 in order for the latter to analyze its content. In this example the processing module MT1 deduces from the data received that an audio connection can be set up.

As shown by the arrow F7, the processing module MT1 then generates a fallback message (“MODIFY message”) that is sent to the calling terminal T1 and contains data that indicates the type of connection (audio) that may be set up with the called terminal T2; this data preferably constitutes the audio identifier BC2 and requires a fallback acceptance message.

As shown by the arrow F8, if the calling terminal T1 accepts fallback it generates and sends an acceptance message (“MODIFY COMPLETE”) containing data that is representative of the type of audio connection to the switching centre MSC1 that is accepted and preferably constitutes the “audio” identifier BC2.

On receiving the acceptance message, the processing module MT1 of the switching centre MSC1 deduces from the data it contains that it is authorized to fallback to the audio connection and then sets up the audio connection between the calling terminal T1 and the called terminal T2, as shown by the arrow F9; this terminates the fallback procedure.

Other messages that are not directly related to the invention may be exchanged between the various equipments involved in setting up a connection, and in particular the switching centers and/or the calling and called terminals.

The processing modules MT of the switching centers MSC may take the form of electronic circuits, software (or data processing) modules, or a combination of circuits and software.

The invention is not limited to the embodiments of a mobile switching centre, communications installation and fallback method described hereinabove by way of example, and encompasses all variants thereof that the person skilled in the art might envisage that fall within the scope of the following claims.

Thus an installation is described hereinabove, by way of non-limiting example, in which the networks support ITU ISUP signaling. However, the invention is not limited to networks that support this type of signaling. It relates generally to all non-NGN networks that support signaling enabling multimedia and audio connections to be set up.

1. A method of fallback from a multimedia connection set-up request to an audio connection set-up request in a communications installation including at least one cellular communications network (N) that does not have an NGN architecture, which method is characterized in that, on receipt of a request to set up a multimedia connection between a calling mobile terminal (T1) and a called terminal (T2), it attempts to set up said multimedia connection with said called terminal (T2) and then, if it is impossible to set up said multimedia connection, attempts to set up an audio connection between said calling terminal (T1) and said called terminal (T2).

2. A method according to claim 1, characterized in that on receipt of said multimedia connection set-up request said calling terminal (T1) is sent an acknowledgement indicating that its connection set-up request will be processed.

3. A method according to claim 1, characterized in that set-up is attempted by sending a multimedia connection set-up request to a called switching centre (MSC2) that manages the connections of said called terminal (T2).

4. A method according to claim 3, characterized in that said request takes the form of an ISUP IAM message.

5. A method according to claim 3, characterized in that, if it is impossible to set up said multimedia connection, a response message is generated containing data indicating why it is impossible.

6. A method according to claim 5, characterized in that said response message takes the form of an ISUP RELEASE message.

7. A method according to claim 5, characterized in that on receipt of said response message the data that it contains is analyzed to determine the cause of it being impossible to set up the multimedia connection, and said cause is then compared to at least one selected cause in order to proceed to said fallback if said cause is identical to said selected cause.

8. A method according to claim 3, characterized in that, after said multimedia connection set-up attempt, said called switching centre (MSC2) is sent a request to set up a fallback audio connection between said calling terminal (T1) and said called terminal (T2) and, on receipt of said request to set up a fallback audio connection, a response message is generated containing data indicating whether it is possible or impossible to set up an audio connection with said called terminal (T2).

9. A method according to claim 8, characterized in that said fallback audio connection set-up request takes the form of an ISUP IAM message.

10. A method according to claim 8, characterized in that said response message takes the form of an ISUP ACM or ISUP CONNECT message.

11. A method according to claim 1, characterized in that, if it is possible to set up the fallback connection, said calling terminal (T1) is sent a message indicating that it is possible to set up the fallback connection and requiring it to send a message accepting said fallback and, on receipt of an acceptance message, the audio connection between said calling terminal (T1) and said called terminal (T2) is set up.

12. A method according to claim 1, characterized in that the connections of said calling terminal (T1) are managed by a calling mobile switching centre (MSC1) and multimedia connection set-up and audio connection set-up are attempted by said calling mobile switching centre (MSC1).

13. A mobile switching centre (MSC) for a communications installation that includes at least one cellular communications network (N) that does not have an NGN architecture, which mobile switching centre is characterized in that it comprises processing means (MT) adapted to implement a fallback method according to claim 1.
